(19) United States
(12) Patent Application Publication
(10) Pub. No.: US 2022/0054888 A1
(43) Pub. Date: Feb. 24, 2022

(54) THERAPEUTIC OR EXERCISE PUTTY SPECIALLY FORMULATED TO REDUCE TRANSMISSION OF HARMFUL VIRUSES, BACTERIA AND MICROBIAL PATHOGENS

(71) Applicant: DEPCO, INC., Hauppauge, NY (US)

(72) Inventors: M. Gregory Minuto, Smithtown, NY (US); Stephen Mlcoch, Manorville, NY (US)

(21) Appl. No.: 17/404,552

(22) Filed: Aug. 17, 2021

Related U.S. Application Data
(60) Provisional application No. 63/067,109, filed on Aug. 18, 2020.

(51) Int. Cl. A63B 23/16; C08G 77/398; C08K 5/00; C08K 5/42; C08K 3/30; C08K 5/56

(52) U.S. Cl. CPC A63B 23/16; C08G 77/398; C08K 5/0075; C08K 2003/3045; C08K 3/30; C08K 5/56; A63B 2209/00; C08K 5/42

(57) ABSTRACT

A therapeutic or exercise putty includes a boronated silicone elastomer serving as the base ingredient and copper sulfate, zinc sulfate, copper oxide, zinc oxide or zinc pyrithione as a secondary ingredient mixed with the base putty or in combination with an antistatic ingredient. The inclusion of any one of the aforementioned secondary ingredients or the antistatic ingredient will reduce the risk of transmission of or infection from viruses, bacteria and microbial pathogens in or on the surface of the putty when the putty is used for hand rehabilitation or exercise by patients.

### CROSS-REFERENCE TO RELATED APPLICATIONS

This application is related to U.S. Provisional Application Ser. No. 63/067,109, filed on Aug. 18, 2020, and titled “Therapeutic Or Exercise Putty Specially Formulated To Reduce Transmission Of Harmful Viruses, Bacteria And Microbial Pathogens”, the disclosure of which is incorporated herein by reference and on which priority is hereby claimed.

### BACKGROUND OF THE INVENTION

### Field of the Invention

The present invention relates to therapeutic or exercise putties specially made for use by patients who have strength issues or require rehabilitation.

### Description of the Related Art

Many orthopedic and physical therapists treat patients who have hand maladies. These maladies cover a wide range of issues from people who have strength issues to those who have issues with arthritis. Much of the rehabilitation is done through exercise. One of the ways exercise is done is with therapeutic putty.

One issue, which is part of current times of 2020, is the concern of the spread of viruses, unhealthy bacteria and microbial pathogens due to interaction and contact with other people, shared products and used materials. In rehabilitation environments, this concern is greater than ever before, especially for people that are not perfectly healthy. Removing risks associated with the need for people to have rehabilitation and exercise activities is an essential objective in treating patients in order to attain good health.

### OBJECTS AND SUMMARY OF THE INVENTION

It is an object of the present invention to provide a therapeutic or exercise putty which helps resolve the problem and concern of any exposure to viruses, bacteria and microbial pathogens during rehabilitation and exercise using a hand exercise putty.

The invention is directed to a therapeutic or exercise putty, which is manipulated by a patient and which includes a base putty formulation, such as a boronated silicone elastomer, and one of the antimicrobial ingredients disclosed herein or equivalents thereof added to and mixed with the base putty formulation that will act to alleviate contact and exposure to undesired viruses, bacteria and microbial pathogens when a patient is undergoing hand therapeutic exercises.

These and other objects, features and advantages of the present invention will be apparent from the following detailed description of illustrative embodiments thereof.

### DETAILED DESCRIPTION OF THE PREFERRED EMBODIMENTS

The invention is directed to a therapeutic or exercise putty, in which copper sulfate, zinc sulfate, copper oxide, zinc oxide or zinc omadine® is mixed with the base putty. The inclusion of any one of these ingredients will eradicate or at least reduce viruses, bacteria and microbial pathogens from the putty and permit proper safe rehabilitation and exercise by patients. These ingredients inherently have antimicrobial properties. These ingredients can kill bacteria, fungi and pathogens as well as eliminating viruses due to the copper and zinc components combined with the sulfur or as an oxide. The copper or zinc binds with the proteins associated with these microbials and kills bacteria and eradicates viruses by the disruption caused by this contact. This invention permits safe use in any patient environment, long term storage between treatments and eliminates exposure risks during multiple use of the same putty.

The therapeutic base putty is much like the Dow Corning Q2-3233, which is a boronated silicone elastomer. This elastomer may vary in viscosity and color. Generally, the Dow Corning Q2-3233 silicone elastomer will resist viruses, bacteria and microbial pathogens when mixed with any one of the ingredients disclosed herein or equivalents thereof.

Another agent ingredient that may be added to the base putty with or without the antimicrobials disclosed herein is an antistatic ingredient, or an “antistat”, as is commonly known, such as Dow Corning 1-6136 Antistat (a cationic alkoxy silane which is designated as 3-trimethoxysilylpropyloctadecyidimethyl ammonium chloride). This ingredient having an anti-static characteristic contributes to further safe use and helps to reduce virus exposure to putty users. Certain viruses need an electrostatic charge to be present in order to adhere to materials before it can attach to living cells. This characteristic of the 1-6136 Antistat product and other antistats prevents or reduces the ability of viruses and microbes to stick or adhere to the putty surface.

Inclusion of the antimicrobial ingredients disclosed herein, when individually part of the putty mixture, helps in the eradication, elimination or reduction of exposure to harmful viruses, bacteria and microbial pathogens. Exposure risks to patients from use of the therapeutic and exercise putty of the present invention are eliminated or at least minimized.

The preferred formulations for such a therapeutic putty, containing the antimicrobial ingredients disclosed herein or equivalents thereof, can be the Dow Corning Q2-3233 base putty mixed with copper sulfate, zinc sulfate, copper oxide, zinc oxide or zinc omadine® (zinc 2-pyridinethiol-1-oxide, also referred to as zinc pyrithione) in a preferred amount of the mixture from about 0.1% to about 5% of the total formula. The inclusion of the Dow Corning 1-6136 Antistat ingredient or other antistat into the mixture with copper sulfate, zinc sulfate, copper oxide, zinc oxide or zinc omadine® provides further user protection based on the antistatic characteristic of this ingredient. The preferred amount of this 1-6136 Antistat ingredient or other antistat can be from about 0.1% to about 5% of the new mixture or it can be added alone with the Dow Corning Q2-3233 base putty by the same percentage of total weight mentioned above. More specifically, the preferred prophetic formulations for the therapeutic putty of the present invention are as follows:

About 0.1% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the putty, plus about 99.9% (percentage of total weight) boronated silicone elastomer; to about 5% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the putty, plus about 95% (percentage of total weight) boronated silicone elastomer; or

About 0.1% (percentage of total weight) Antistat 1-6136 agent or another ingredient which reduces the electrostatic attraction of viruses and microbes to the surface of the putty, plus about 99.9% (percentage of total weight) boronated silicone elastomer; to about 5% (percentage of total weight) Anti stat 1-6136 agent or another ingredient which reduces the electrostatic attraction of viruses and microbes to the surface of the putty, plus about 95% (percentage of total weight) boronated silicone elastomer; or

About 0.1% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the putty, and about 0.1% (percentage of total weight) Antistat 1-6136 agent or another ingredient which reduces the electrostatic attraction of viruses or microbes to the surface of the putty, plus about 99.8% (percentage of total weight) boronated silicone elastomer; to about 5% (percentage of total weight) copper sulfate, zinc sulfate, copper oxide, zinc oxide or zinc omadine® or another ingredient which kills, or prevents or inhibits the growth of, bacteria and microbes and eradicates or reduces the concentration of viruses in the putty and about 5% (percentage of total weight) Antistat 1-6136 agent or another ingredient which reduces the electrostatic attraction of viruses and microbes to the surface of the putty, plus about 90% (percentage of total weight) boronated silicone elastomer.

Other secondary ingredients (dyes, analgesics, etc.) may be added to the therapeutic putty that may reduce the approximate percentages in total weight of the boronated silicone elastomer in the prophetic formulations mentioned above, as long as the percentage of the ingredient which kills, or prevents or inhibits the growth of, bacteria and microbes and eradicates or reduces the concentration of viruses in the putty is in the range of about 0.1% of the total weight of the therapeutic putty product and about 5% of the total weight of the therapeutic putty product, and as long as the percentage of the ingredient which reduces the electrostatic attraction of viruses and microbes to the surface of the putty is in the range of about 0.1% of the total weight of the therapeutic putty product and about 5% of the total weight of the therapeutic putty product, each of the ingredients mentioned above (i.e., the ingredient which kills, or prevents or inhibits the growth of, bacteria and microbes and eradicates or reduces the concentration of viruses in the putty and the ingredient which reduces the electrostatic attraction of viruses and microbes to the surface of the putty) being included alone or in combination with the other ingredient in the therapeutic putty product of the present invention.

Tests were performed to determine the efficacy of adding an antimicrobial ingredient to a silicone putty material (i.e., a boronated silicone elastomer putty) used in making a therapeutic or exercise putty formed in accordance with the present invention. A first silicone putty sample made with 0.1% by weight of zinc omadine® (99.9% silicone putty base by weight), a second silicone putty sample made with 0.1% by weight of copper sulfate (99.9% silicone putty base by weight) and a third silicone putty sample made with 0.1% by weight of zinc sulfate (99.9% silicone putty base by weight) were tested, and the results of such tests show over a ninety-nine percent (99%) effectiveness of the zinc omadine®/silicone putty mixture, the copper sulfate/silicone putty mixture and the zinc sulfate/silicone putty mixture, in reducing the presence of microbials.

More specifically, an independent laboratory was engaged to study the antibacterial efficacy of silicone putty mixtures having 0.1% by weight of zinc omadine® in a first sample, 0.1% by weight of copper sulfate in a second sample and 0.1% by weight of zinc sulfate in a third sample. The tests were performed in accordance with ISO 22196:2011 standard, and the challenge organism was Methicillin-resistant Staphylococcus aureus, ATCC 43300. Each of the antimicrobial ingredients was mixed into the putty base during sample fabrication and evenly dispersed during mixing the ingredient into the putty formula.

A summary of the test methodology is as follows:

A suspension of the test bacteria (methicillin-resistant S. aureus) was prepared in 1:500 nutrient broth and adjusted to yield approximately 10⁶-10⁷ cfu/mL. The samples provided by the applicant herein (both test and control) were placed in sterile petri dishes, inoculated in triplicate with 200 μL of the previously prepared bacterial suspensions, and overlaid with sterile polyethylene cover films. Baseline readings were conducted to determine the exact starting organism concentration by adding 10 mL of Dey-Engley neutralizing broth to three control samples. The samples were mixed well, serially diluted in phosphate buffered saline (PBS), and plated in duplicate on trypticase soy agar (TSA). Test and control coupons were processed in an identical fashion after 24 hours, and all plates incubated at 35° C. for 24-48 hours. After incubation, all plates were counted, and the percent and log differences calculated.

The tests performed by the independent laboratory showed that the efficacy of antimicrobial ingredients (zinc omadine®, copper sulfate and zinc sulfate) mixed in the silicone putty samples was found to be significant when compared to untreated silicone putty control samples in reducing by 99.99% (for the copper sulfate/putty mixture), 99.98% (for the zinc sulfate/putty mixture) and 99.57% (for the zinc omadine®/putty mixture) levels of challenge microorganism Staphylococcus aureus from inoculum challenge levels at 24 hours post-inoculum. It should be noted that the efficacy of the untreated silicone putty control samples was also significant in reducing by 99.04% for each control sample levels of the challenge microorganism, indicating the product itself without the added copper sulfate, zinc sulfate and zinc omadine® may have inherent antimicrobial properties.

The therapeutic putty of the present invention, such as disclosed in the above prophetic formulations, will aid in preventing contact, exposure or the spread of viruses, bacteria and microbial pathogens from a patient or therapist to the putty and/or from the putty surface to the patient or therapist when human contact to the hand skin begins, sustained during rehabilitation exercise or from reuse after storage. The putty mixture formulation of the present invention eradicates, eliminates or at least reduces potential exposure risks present in the environment when the therapeutic or exercise putty of the present invention is used by a patient.

Although illustrative embodiments of the present invention have been described herein, it is to be understood that the invention is not limited to those precise embodiments, and that various other changes and modifications may be effected therein by one skilled in the art without departing from the scope or spirit of the invention.

What is claimed is:

1. A therapeutic or exercise putty, which comprises:
a silicone putty base; and
an antimicrobial ingredient mixed with the silicone putty base.

2. A therapeutic or exercise putty as defined by claim 1, wherein the silicone putty base is formed from boronated silicone elastomer.

3. A therapeutic or exercise putty as defined by claim 2, wherein the silicone putty base is Part No. Q2-3233 manufactured by The Dow Chemical Company of Midland, Mich.

4. A therapeutic or exercise putty as defined by claim 2, wherein the antimicrobial ingredient is selected from the group consisting of copper sulfate, zinc sulfate, copper oxide, zinc oxide, zinc omadine®, zinc pyrithione and zinc 2-pyridinethiol-1-oxide.

5. A therapeutic or exercise putty as defined by claim 4, wherein the antimicrobial ingredient is in the range of about 0.1% (percentage of total weight) to about 5% (percentage of total weight); and
wherein the boronated silicone elastomer is in the range of about 99.9% (percentage of total weight) to about 95% (percentage of total weight).

6. A therapeutic or exercise putty as defined by claim 4, which further comprises:
an antistatic ingredient mixed with the silicone putty base;
wherein the antimicrobial ingredient is in the range of about 0.1% (percentage of total weight) to about 5% (percentage of total weight);
wherein the antistatic ingredient is in the range of about 0.1% (percentage of total weight) to about 5% (percentage of total weight); and
wherein the boronated silicone elastomer is in the range of about 99.8% (percentage of total weight) to about 90% (percentage of total weight).

7. A therapeutic or exercise putty as defined by claim 6, wherein the antistatic ingredient is a cationic alkoxy silane.

8. A therapeutic or exercise putty as defined by claim 6, wherein the antistatic ingredient is 3-trimethoxysilylpropyloctadecyidimethyl ammonium chloride.

9. A therapeutic or exercise putty as defined by claim 4, wherein the antimicrobial ingredient is copper sulfate at about 0.1% (percentage of total weight); and
wherein the boronated silicone elastomer putty base is at about 99.9% (percentage of total weight).

10. A therapeutic or exercise putty as defined by claim 4, wherein the antimicrobial ingredient is zinc sulfate at about 0.1% (percentage of total weight); and
wherein the boronated silicone elastomer putty base is at about 99.9% (percentage of total weight).

11. A therapeutic or exercise putty as defined by claim 4, wherein the antimicrobial ingredient is zinc omadine® at about 0.1% (percentage of total weight); and
wherein the boronated silicone elastomer putty base is at about 99.9% (percentage of total weight).

12. A therapeutic or exercise putty, which comprises:
a silicone putty base; and
an antistatic ingredient mixed with the silicone putty base.

13. A therapeutic or exercise putty as defined by claim 12, wherein the silicone putty base is formed from boronated silicone elastomer.

14. A therapeutic or exercise putty as defined by claim 13, wherein the silicone putty base is Part No. Q2-3233 manufactured by The Dow Chemical Company of Midland, Mich.

15. A therapeutic or exercise putty as defined by claim 13, wherein the antistatic ingredient is a cationic alkoxy silane.

16. A therapeutic or exercise putty as defined by claim 13, wherein the antistatic ingredient is 3-trimethoxysilylpropyloctadecyidimethyl ammonium chloride.

17. A therapeutic or exercise putty as defined by claim 13, wherein the antistatic ingredient is in the range of about 0.1% (percentage of total weight) to about 5% (percentage of total weight); and
wherein the boronated silicone elastomer is in the range of about 99.9% (percentage of total weight) to about 95% (percentage of total weight).
